(19) United States
(12) Patent Application Publication
(10) Pub. No.: US 2024/0379305 A1
(43) Pub. Date: Nov. 14, 2024

(54) KEY STRUCTURE AND MOUSE INCLUDING KEY STRUCTURE

(71) Applicant: Primax Electronics Ltd., Taipei (TW)

(72) Inventors: Chien-Pang Chien, Taipei (TW); Tsu-Hui Yu, Taipei (TW); Tao-Ying Chen, Taipei (TW); Chun-Nan Su, Taipei (TW); Chun-Che Wu, Taipei (TW)

(21) Appl. No.: 18/217,293

(22) Filed: Jun. 30, 2023

(30) Foreign Application Priority Data
May 12, 2023 (TW) 112117833

(51) Int. Cl. H01H 13/14; G06F 3/02; G06F 3/0354

(52) U.S. Cl. CPC H01H 13/14; G06F 3/0202; G06F 3/03543

(57) ABSTRACT

A key structure includes a keycap, a connecting member, a fixing member, a light emitter and a light receiver. The connecting member is connected to an inner top surface of the keycap and extends downwards, and the connecting member has a first opening through the connecting member. The fixing member has a second opening through the fixing member, in which when the keycap is initially pressed and then continues to be pressed, the keycap moves in a direction, and the connecting member moves with the keycap, and an overlapping region defined by the first opening and the second opening gradually becomes larger or smaller. The light emitter is laterally adjacent to the second opening of the fixing member. The light receiver is laterally adjacent to the first opening of the connecting member.

### FIELD OF THE INVENTION

The present disclosure relates to a key structure, in particular to a key structure applicable to an input device.

### BACKGROUND OF THE INVENTION

A Hall sensor or a force sensitive resistor (FSR) is usually used in a pressure-sensitive key of a mouse, but its cost is high, and when a sensing force value is small, the force sensitive resistor has high requirements for assembly and is also sensitive to environment.

### SUMMARY OF THE INVENTION

The present disclosure provides a key structure, which includes a keycap, a connecting member, a fixing member, a light emitter and a light receiver. The connecting member is connected to an inner top surface of the keycap and extends downwards, and the connecting member has a first opening through the connecting member. The fixing member has a second opening through the fixing member, in which when the keycap is initially pressed and then continues to be pressed, the keycap moves along a direction, and the connecting member moves with the keycap, and an overlapping region defined by the first opening and the second opening gradually becomes larger or smaller. The light emitter is laterally adjacent to the second opening of the fixing member. The light receiver is laterally adjacent to the first opening of the connecting member.

In some embodiments of the present disclosure, the connecting member extends substantially along the direction.

In some embodiments of the present disclosure, the first opening extends substantially along the direction.

In some embodiments of the present disclosure, the second opening extends substantially along another direction perpendicular to the direction.

In some embodiments of the present disclosure, a width of the first opening is smaller than a width of the second opening.

In some embodiments of the present disclosure, the first opening has a tapered shape.

In some embodiments of the present disclosure, the first opening is arc taper-shaped or straight taper-shaped.

In some embodiments of the present disclosure, a length of the first opening is greater than or equal to a travel distance of the keycap.

In some embodiments of the present disclosure, the keycap has a pivot end and a pressing end oppositely disposed, and the key structure further includes: an elastic element, connected to the inner top surface of the keycap and close to the pressing end of the keycap.

In some embodiments of the present disclosure, when the keycap is initially pressed and then continues to be pressed, the keycap moves in the direction, and the connecting member moves with the keycap, and the overlapping region defined by the first opening and the second opening gradually becomes larger, and a voltage value outputted by the light receiver gradually becomes smaller.

In some embodiments of the present disclosure, the light emitter and the light receiver are substantially aligned with the second opening.

In some embodiments of the present disclosure, the key structure further includes a circuit board, and the light emitter and the light receiver are disposed on the circuit board, and the circuit board has a through opening, and the fixing member is disposed in the through opening.

The present disclosure also provides a mouse including the aforementioned key structure.

### BRIEF DESCRIPTION OF THE DRAWINGS

Aspects of the present disclosure are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a schematic perspective view of a key structure according to an embodiment of the present invention.

FIG. 2 is a schematic side view of a keycap according to an embodiment of the present invention.

FIG. 3 is a partial perspective view of a key structure according to an embodiment of the present invention.

FIGS. 4 to 7 are schematic side views of a key structure being pressed from beginning to being pressed to end according to an embodiment of the present invention.

FIG. 8 is a perspective view of a mouse according to an embodiment of the present invention.

### DETAIL DESCRIPTION OF THE PREFERRED EMBODIMENT

The advantages and features of the present disclosure and the method for achieving the same will be described in more detail with reference to exemplary embodiments and accompanying drawings to make it easier to understand. However, the present disclosure can be implemented in different forms and should not be construed as being limited to the embodiments set forth herein. On the contrary, for those skilled in the art, the provided embodiments will make this disclosure more thorough, comprehensive and complete to convey the scope of the present disclosure.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in background of the invention, the Hall sensor or the force sensitive resistor (FSR) is usually used in the pressure-sensitive key of the mouse, but its cost is high, and when the sensing force value is small, the force sensitive resistor has high requirements for assembly and is also sensitive to the environment. Accordingly, the present invention provides a key structure. When a keycap is pressed, an overlapping region defined by a first opening of a connecting member connected to the keycap and a second opening of a fixing member gradually becomes larger or smaller, so that light intensity of light emitted by a light emitter through the overlapping region gradually increases or decreases, so that a voltage value outputted by a light receiver changes gradually (e.g., gradually decreases or increases) and a corresponding key signal is generated to perform a gradual change in a specific action, such as controlling a playback speed of a video, controlling a volume, or controlling a brightness of a color. The key structure of the present invention may be applied to various input devices (e.g., a mouse) to perform the gradual change in the specific action. Various embodiments of the key structure of the present invention will be described in detail below.

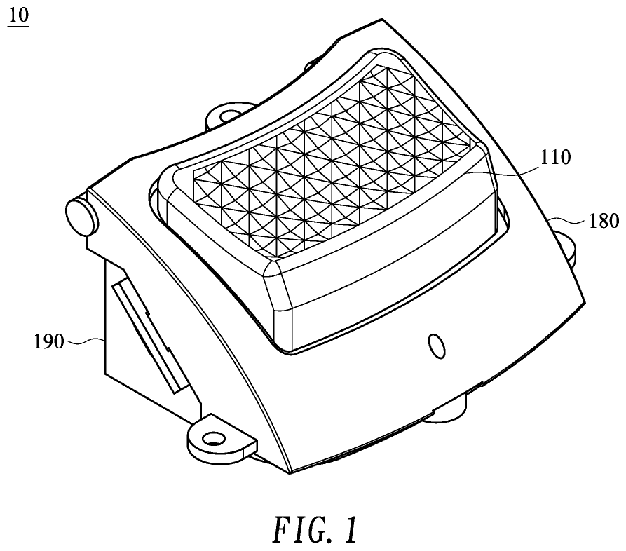

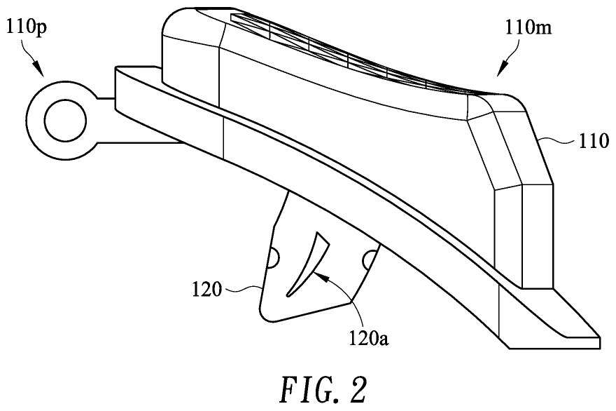

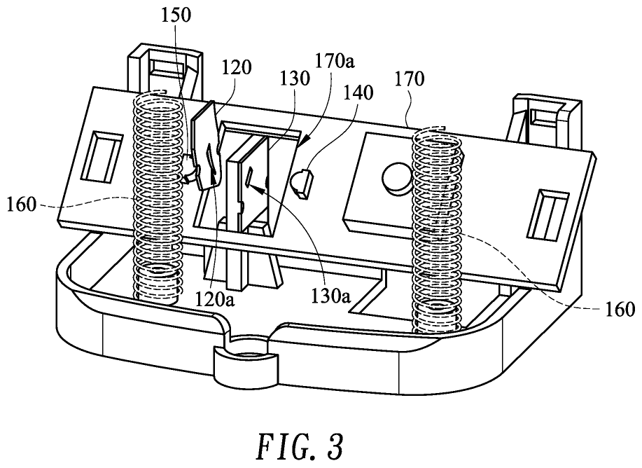

FIG. 1 is a schematic perspective view of a key structure according to an embodiment of the present invention. FIG. 2 is a schematic side view of a keycap according to an embodiment of the present invention. FIG. 3 is a partial perspective view of a key structure according to an embodiment of the present invention. Referring to FIGS. 1 to 3, the key structure 10 includes a keycap 110, a connecting member 120, a fixing member 130, a light emitter 140 and a light receiver 150.

In some embodiments, as shown in FIG. 2, the keycap 110 has a pivoting end (or called a rotating shaft end) 110p and a pressing end 110m opposite disposed. When the user presses the keycap 110, the keycap 110 swings down. In some embodiments, as shown in FIGS. 1 and 2, the key structure 10 further includes an upper cover 180 and a lower cover 190, and the upper cover 180 is located over the lower cover 190, and the pivot end 110p of the keycap 110 is pivotally connected to one end of the upper cover 180. However, the present invention is not limited to the foregoing embodiments. In other embodiments, a keycap excludes a pivoting end, and when the keycap is pressed, the keycap moves downward.

Referring to FIGS. 2 and 3, the connecting member 120 is connected to an inner top surface of the keycap 110 and extends downward. The connecting member 120 has a first opening 120a through the connecting member 120. In some embodiments, the connecting member 120 extends substantially along a direction (hereinafter referred to as a direction D, such as an arc direction) in which the keycap 110 moves when pressed. In some embodiments, the first opening 120a extends substantially along the direction D. In some embodiments, the first opening 120a has a tapered shape. In some embodiments, a width of the first opening 120a is tapered from top to bottom, but the invention is not limited thereto. In other embodiments, a width of the first opening may be tapered from bottom to top. In some embodiments, the first opening 120a is arc taper-shaped, straight taper-shaped or has another suitable shape.

Please refer to FIG. 3, the fixing member 130 has a second opening 130a through the fixing member 130. In some embodiments, the second opening 130a extends substantially along another direction perpendicular to the direction D. In some embodiments, the second opening 130a is rectangular or has another suitable shape.

It should be noted that the present invention is not limited to the foregoing embodiments, as long as the keycap is pressed, the overlapping region defined by the first opening and the second opening can gradually become larger or smaller, and thus the voltage value outputted by the light receiver 150 can be changed gradually.

Referring to FIG. 3, the light emitter 140 is laterally adjacent to the second opening 130a of the fixing member 130. The light receiver 150 is laterally adjacent to the first opening 120a of the connecting member 120. In some embodiments, the light emitter 140 (e.g., a light emitting surface of the light emitter 140) and the light receiver 150 (e.g., a light receiving surface of the light receiver 150) are substantially aligned with the second opening 130a. In some embodiments, the second opening 130a is located within a projection of the light emitter 140 to the fixing member 130 and within a projection of the light receiver 150 to the fixing member 130.

It is worth noting that the present invention controls an amount of change in the overlapping region defined by the first opening 120a and the second opening 130a through a travel distance of the keycap 110, and converts it into a change in the voltage value outputted by the light receiver 150. Therefore, detection stability of the light emitter 140/light receiver 150 of the key structure of the present invention is high, and resolution is good. In addition, its cost is lower than that of the Hall sensor or the force sensitive resistor.

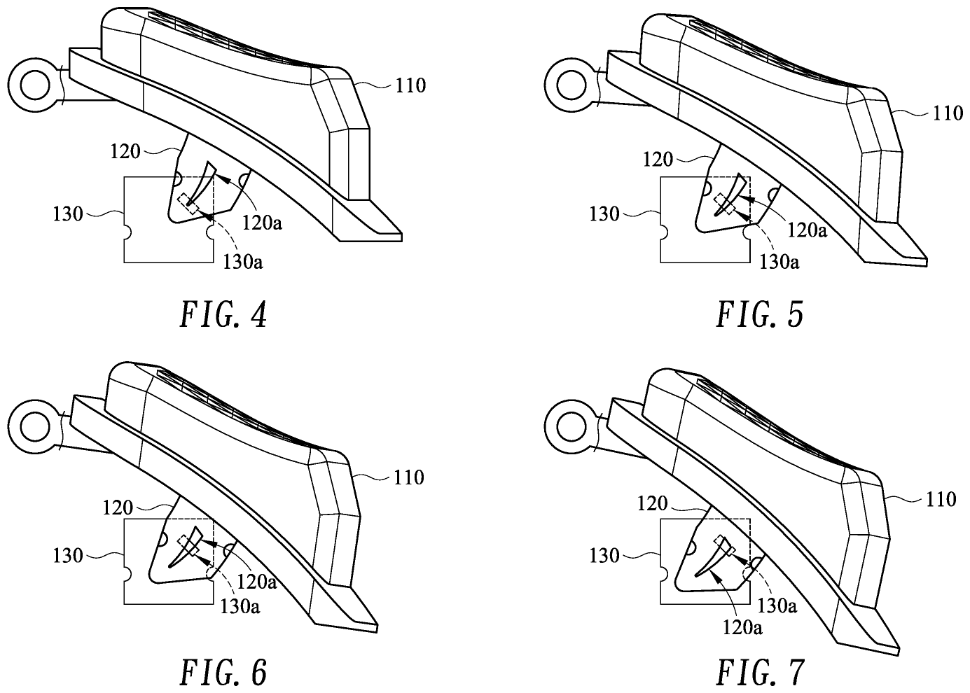

FIGS. 4 to 7 are schematic side views of a key structure being pressed from beginning to being pressed to end according to an embodiment of the present invention. Referring FIG. 3 and FIGS. 4 to 7, when the keycap 110 is initially pressed and then continues to be pressed, the keycap 110 moves in the direction D, and the connecting member 120 moves with the keycap 110, and the overlapping region defined by the first opening 120a and the second opening 130a gradually becomes larger (as shown in FIGS. 4 to 7) or smaller. In some embodiments, when the keycap 110 is initially pressed and then continues to be pressed, the keycap 110 moves in the direction D, and the connecting member 120 moves along with the keycap 110, and the overlapping region defined by the first opening 120a and the second opening 130a gradually becomes larger, and the voltage value outputted by the light receiver 150 gradually becomes smaller. In some embodiments, when the travel distance of the keycap 110 gradually increases, the voltage value outputted by the light receiver 150 gradually becomes smaller, which shows a linear change or a nearly linear change.

In some embodiments, the width of the first opening 120a is smaller than a width of the second opening 130a. In some embodiments, a length of the first opening 120a is greater than or equal to the travel distance of the keycap 110. In some embodiments, the travel distance of the keycap 110 is greater than or equal to 1.5 mm, even greater than or equal to 2.0 mm or 2.5 mm.

In some embodiments, as shown in FIGS. 2 and 3, the key structure further includes an elastic element 160, which is connected to the inner top surface of the keycap 110 and is close to the pressing end 110m of the keycap 110, so when the keycap 110 is pressed then released by the user, the keycap 110 returns to its original position.

In some embodiments, as shown in FIG. 3, the key structure further includes a circuit board 170, and the light emitter 140 and the light receiver 150 are disposed on the circuit board 170. In some embodiments, the circuit board 170 has a through opening 170a, and the fixing member 130 is disposed in the through opening 170a.

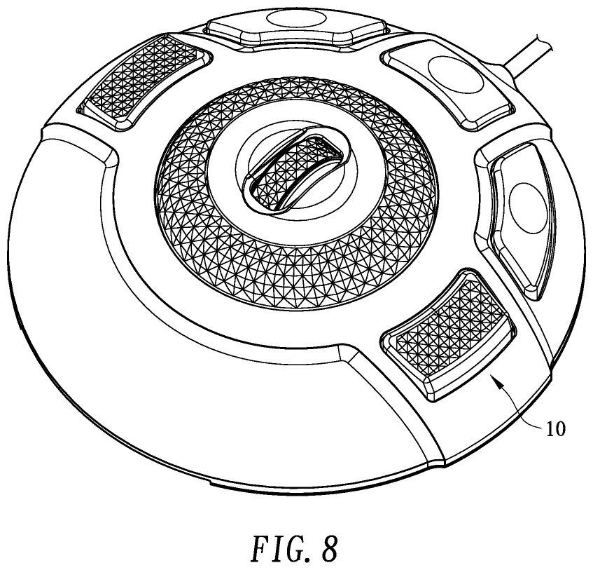

FIG. 8 is a perspective view of a mouse according to an embodiment of the present invention. As shown in FIG. 8, the mouse includes the key structure 10 shown in FIG. 1. However, the present invention is not limited to the foregoing embodiments, and the key structure 10 of the present invention may also be applied to other input devices.

However, the above are only the preferred embodiments of the present disclosure, and should not be used to limit the scope of implementation of the present disclosure, that is, simple equivalent changes and modifications made in accordance with claims and description of the present disclosure are still within the scope of the present disclosure. In addition, any embodiment of the present disclosure or claim does not need to achieve all the objectives or advantages disclosed in the present disclosure. In addition, the abstract and the title are not intended to limit the scope of claims of the present disclosure.

What is claimed is:

1. A key structure, comprising:
a keycap;
a connecting member, connected to an inner top surface of the keycap and extending downwards, the connecting member having a first opening through the connecting member;
a fixing member, having a second opening through the fixing member, wherein when the keycap is initially pressed and then continues to be pressed, the keycap moves in a direction, and the connecting member moves with the keycap, and an overlapping region defined by the first opening and the second opening gradually becomes larger or smaller;
a light emitter, laterally adjacent to the second opening of the fixing member; and
a light receiver, laterally adjacent to the first opening of the connecting member.

2. The key structure of claim 1, wherein the connecting member extends substantially along the direction.

3. The key structure of claim 1, wherein the first opening extends substantially along the direction.

4. The key structure of claim 1, wherein the second opening extends substantially along another direction perpendicular to the direction.

5. The key structure of claim 1, wherein a width of the first opening is smaller than a width of the second opening.

6. The key structure of claim 1, wherein the first opening has a tapered shape.

7. The key structure of claim 1, wherein the first opening is arc taper-shaped or straight taper-shaped.

8. The key structure of claim 1, wherein a length of the first opening is greater than or equal to a travel distance of the keycap.

9. The key structure of claim 1, wherein the keycap has a pivot end and a pressing end oppositely disposed, and the key structure further comprises:
an elastic element, connected to the inner top surface of the keycap and close to the pressing end of the keycap.

10. The key structure of claim 1, wherein when the keycap is initially pressed and then continues to be pressed, the keycap moves in the direction, and the connecting member moves with the keycap, and the overlapping region defined by the first opening and the second opening gradually becomes larger, and a voltage value outputted by the light receiver gradually becomes smaller.

11. The key structure of claim 1, wherein the light emitter and the light receiver are substantially aligned with the second opening.

12. The key structure of claim 1, further comprising:
a circuit board, the light emitter and the light receiver being disposed on the circuit board, the circuit board having a through opening, the fixing member being disposed in the through opening.

13. A mouse, comprising the key structure of claim 1.
